(19) United States
(12) Patent Application Publication
(10) Pub. No.: US 2012/0135194 A1
(43) Pub. Date: May 31, 2012

(54) HIGH-VISCOSITY MATERIAL APPLICATION DEVICE, HIGH-VISCOSITY MATERIAL APPLICATION METHOD, AND HIGH-VISCOSITY MATERIAL COATING

(75) Inventors: Kenichi TAKEDA, Tochigi (JP); Yoshiyuki Kumano, Tochigi (JP)

(73) Assignee: HONDA MOTOR CO., LTD., Tokyo (JP)

(21) Appl. No.: 13/301,247

(22) Filed: Nov. 21, 2011

(30) Foreign Application Priority Data
Nov. 24, 2010 (JP) 2010-261558
Nov. 24, 2010 (JP) 2010-261559
Mar. 3, 2011 (JP) 2011-046427

(51) Int. Cl. B32B 3/00; B05D 5/00; B05D 1/26; B05C 5/00; B05D 1/36

(52) U.S. Cl. 428/156; 118/323; 427/402; 427/258

(57) ABSTRACT

A high-viscosity material application device is provided with a discharge portion for discharging a high-viscosity material while moving relatively to a coating surface. The discharge portion includes a plurality of successive openings spaced in an application direction.

### BACKGROUND OF THE INVENTION

1. Field of the Invention

The invention relates to a high-viscosity material application device, a high-viscosity material application method, a high-viscosity material coating, and a soundproof/vibration-proof sheet.

2. Related Art

Conventionally, on a body of an automobile etc., in order to provide soundproof and vibration-proof effects, there are applied a high-viscosity material to form a high-viscosity material coating. For example, a high-viscosity material coating is formed on a surface (coating surface) of a floor panel and then a floor mat or the like is placed on the high-viscosity material coating.

Specifically, using a robot or the like, a nozzle, to which the high-viscosity material can be supplied, is moved to apply the high-viscosity material side by side onto the coating surface sequentially in a belt-like shape, thereby forming a high-viscosity material coating over a wide area of the surface.

Patent Document 1 discloses a technology which, using a parallel nozzle having nozzle passages respectively extending with a given parallel width from an introduction port of the nozzle to the exhaust port (discharge portion) thereof and having a given clearance width between them, applies high-viscosity materials in a uniform thickness.

Patent Document 1: JP-A-2005-262011

In order to provide proper soundproof and vibration-proof effects, the high-viscosity material coating must be thick. However, even when the nozzle disclosed in Patent Document 1 is used, there cannot be provided a high-viscosity material, coating having a uniform and sufficient thickness. When the thickness of the high-viscosity material coating is not uniform, there can be obtained only the soundproof and vibration-proof effects of such level that the smallest thickness portion of the high-viscosity material coating can provide. Therefore, portion of the high-viscosity material coating having an unnecessarily large thickness occupies the wide range thereof and thus the high-viscosity materials are consumed, more than needed, thereby increasing a cost of the high-viscosity material coating.

Also in the conventional technology, since, when a clearance exists between the mutually adjacently formed belt-like high-viscosity material portions, the soundproof and vibration-proof effects are lowered greatly, the end portions of the high-viscosity material portions are superimposed on top of each other. However, such superimposition causes the end portions to rise and the rising portion interferes with a peripheral part such as a floor mat to be placed on the high-viscosity material coating, thereby having an ill influence on their assembling performance.

### SUMMARY OF THE INVENTION

Embodiments of the invention relate to a high-viscosity material coating, and device and method for applying high-viscosity materials.

### BRIEF DESCRIPTION OF THE DRAWINGS

FIG. 1 is a conceptual view of a high-viscosity material application device.

FIG. 2 (a) is a bottom view of a nozzle according to a first embodiment. FIG. 2 (b) is a section view taken along the B-B line shown in FIG. 2 (a).

FIG. 3 (a) is a conceptual view of a state where high-viscosity materials discharged from the nozzle are applied on a coating serf surface. FIG. 3 (b) is a section view taken along the B-B line shown in FIG. 3 (a).

FIGS. 4 (a) to 4 (c) are respectively conceptual views of the transverse section views of high-viscosity material layered bodies. Specifically, FIG. 4 (a) shows a state after end of a first application step, FIG. 4 (b) shows a state after end of a second application step, and FIG. 4 (c) shows a state after end of a third application step, respectively.

FIG. 5 is a bottom view of a nozzle according to a second embodiment.

FIG. 6 (a) is a conceptual view of a state where high-viscosity materials discharged from the nozzle are applied on a coating surface. FIG. 6 (b) is a section view taken along the B-B line shown in FIG. 6 (a).

FIGS. 7 (a) to 7 (c) are respectively conceptual views of the transverse section views of high-viscosity material layered bodies. Specifically, FIG. 7 (a) shows a state after end of a first application step, FIG. 7 (b) shows a state after end of a second application step, and FIG. 7 (c) shows a state after end of a third application step, respectively.

FIG. 8 is a bottom view of a nozzle according a third embodiment.

FIG. 9 is a conceptual view of the transverse section view of a high-viscosity material superimposed layered body.

### DETAILED DESCRIPTION OF THE EMBODIMENTS

Now, description will be given below of embodiments with reference to the accompanying drawings. Here, the embodiments and modifications thereof described herein are not intended to limit the invention but only to exemplify the invention, and all features or combinations of the features of the embodiments and/or the modifications are not always essential to the invention.

A high-viscosity material used in the embodiments is, for example, a liquid-state melt-seat mainly constituted of acryl emulsion system component. It is in a liquid state at a given temperature, for example, a temperature of 28° C. or higher, whereas it is suddenly hardened when the temperature goes below 28° C.

In the case of the high-viscosity material, even when, on a high-viscosity material layer of several millimeters cooled and hardened, there is further formed another high-viscosity material layer of several millimeters, the high-viscosity material has such strength that can prevent the shapes of the high-viscosity material layers, especially, the shapes of the end portions thereof against deformation. The viscosity of such high-viscosity layer may be 0.8 Pa·s or more.

A member to which the high-viscosity material is applied, is a sheet metal panel such as the floor panel of a body of a car or the like, while it is made of a steel plate such as an SPC steel plate and a galvanized steel plate. However, the member to be coated in the embodiments is not limited to the sheet metal panel but the material thereof is not limited. And, a coating surface, which is a surface of the member to be coated, may also have an uneven shape or an inclined surface unless it includes a large step difference and a large hole.

Now, description will be given below of a high-viscosity material application apparatus 100 according to a first embedment.

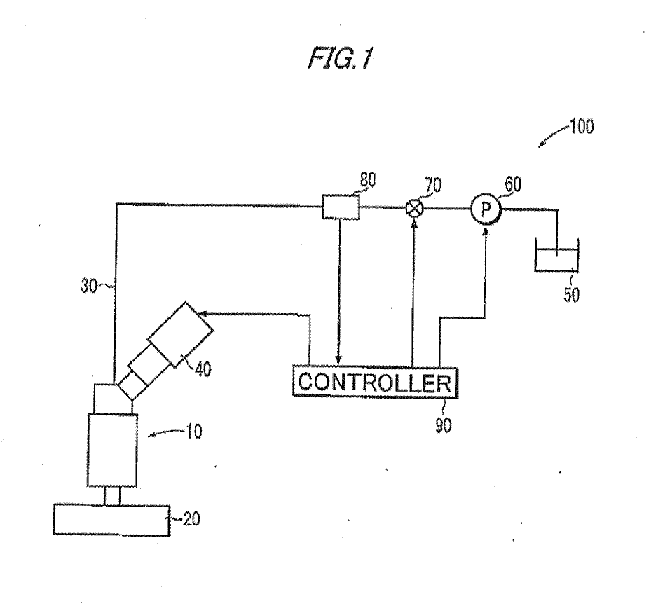

As shown in FIG. 1, the application apparatus 100 includes an application gun 10, a nozzle 20 mounted on a leading end of the application gun 10, a hose 30 with, its leading end connected to the nozzle 20, an articulated robot 40 with the application gun 10 mounted on the leading end of the hand thereof, a tank 50 for storing high-viscosity materials, a pump 60 for sucking in the high-viscosity materials stored in the tank 50 from the rear end of the hose 30 and pressure feeding it within the hose 30, a valve 70 provided, in the middle of the hose 30, a flow meter 80 for detecting the flow rate of the high-viscosity materials being pressure fed within the hose 30, and a control portion 90.

The nozzle 20 is a heat nozzle capable of heating the high-viscosity materials up to a given temperature and hose 30 is also a heat hose capable of heating the high-viscosity materials up to a given temperature. In the case that the high-viscosity materials are heated up to a given temperature, the viscosity of the high-viscosity materials is constant free from the influence of the outside air temperature and is also low, thereby being able to reduce the load of the pump 60.

When the high-viscosity materials heated into its liquid state within the nozzle 20 are discharged from the nozzle 20 and are thereby contacted with the outside air, the heat radiation thereof is started and thus the temperature thereof is lowered, whereby the viscosity of the materials becomes high suddenly.

The control portion 90 is constituted of a CPU, a ROM, a RAM, an I/O and the like and, according to the discharge quantity detected by the flow meter 80, controls the robot 40, pump 60 and valve 70 so that previously determined material application can be made through execution of a previously taught instruction program.

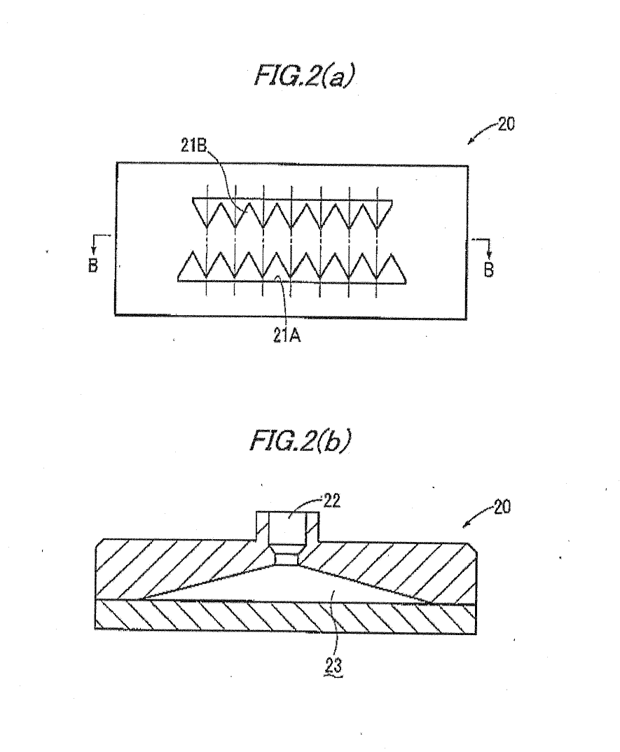

As shown in FIG. 2 (a), the nozzle 20 includes in its bottom surface a discharge portion 21 constituted of a plurality of, here, two successive openings 21A and 21B spaced from each other in the application direction (in the drawing, in the vertical direction). A shape provided by piling up the shapes of the openings 21A and 21B is asymmetric in the application direction and is symmetric in a direction (in the drawing, in the right and left direction) perpendicular to the application direction.

Specifically, the openings 21A, and 21B respectively have a shape in which the base portions of isosceles triangles having the same shape are continuously connected to each other in a direction perpendicular to the application direction, while the two openings are arranged parallel to each other. The vertex portion of an isosceles triangle of one opening (for example, 21A) and the connecting portion of the base portions of the isosceles triangles of the other opening (for example, 21B) is arranged on a straight line. Therefore, the shape, which is obtained by piling up the shapes of the openings 21A and 21B on top of each other, provides a substantially trapezoidal shape, while it is asymmetric in the application direction and symmetric in a direction perpendicular to the application direction.

As shown in FIG. 2 (b), the nozzle 20 includes an introduction, port 22, to which the leading end of the hose 30 can be connected, and a radial introduction passage 23 for connecting together the discharge portion 21 and introduction port 22. Thus, the cross section of a high-viscosity material layer formed of high-viscosity materials discharged from the openings 21A and 21B and bonded onto the coating surface S provides a shape following the shapes of the openings 21A and 21B.

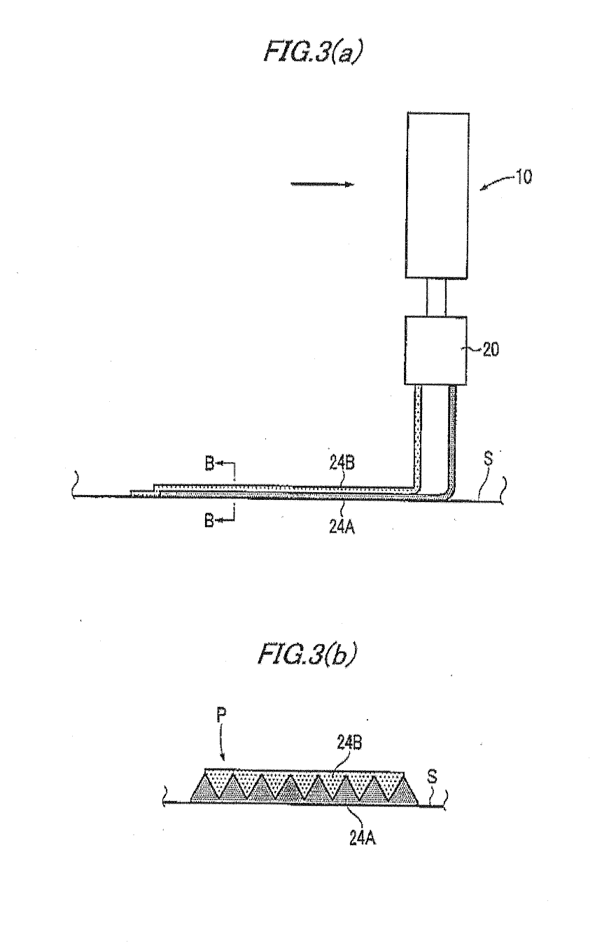

Since the openings 21A and 21B are spaced in the application direction, as shown in FIG. 3 (a), high-viscosity materials discharged simultaneously from the openings 21A and 21B are allowed to flow down while they are spaced in the application direction (in the drawing, in the arrow direction), and are applied onto the coating surface S.

When the materials are applied while the opening 21A is situated on the front side in the application direction and the opening 21B is situated on the trailing side in the application direction, on a high-viscosity material layer 24A formed of the materials discharged from the opening 21A, there is piled up a high-viscosity material layer 24B formed of the materials discharged from the opening 2B. As shown in FIG. 3 (b), the cross section of a high-viscosity material layered body P (high-viscosity material applied portion P) constituted of the two superimposed high-viscosity material layers 24A and 24B provides a substantially trapezoidal shape similar to a shape obtained when the openings 21A and 21B are superimposed in the application direction, while it is asymmetric in the application direction and symmetric in a direction perpendicular to the application direction.

Here, the space between the openings 21A and 21B, the temperature and shear rate of the high-viscosity materials when they are discharged from the nozzle 20, the moving speed of the nozzle 20 and the like can be determined properly in consideration of the distance from the nozzle 20 to the coating surface S, the outside air temperature, the operation efficiency and the like in order that, when the two high-viscosity material layers 24A and 24B are superimposed, the shape of the end portion of the lower high-viscosity material layer 24A can be prevented against deformation.

For example, the height of the triangular shape of the openings 21A and 21B may be about 0.3 mm (millimeters) to several mm, the space between the openings 21A and 21 may be about several mm, the temperature of the high-viscosity materials when they are discharged from the nozzle 20 may be 28° to 30°, the shear rate of the high-viscosity materials when they are discharged from the nozzle 20 may be 10000/sec to 20000/sec, and the moving speed of the nozzle 20 may be 200 mm/min to 1500 mm/min.

The above-structured application apparatus 100, while moving relatively to the coating surface S, discharges the heated high-viscosity materials from the discharge portion 21. The discharged high-viscosity materials flow down and reach the coating surface S, where they are cooled and hardened, thereby forming a belt-shaped high-viscosity material layered body P.

Now, description will be given below of a method for applying high-viscosity materials using the application apparatus 100. The operation of the application apparatus 100 is controlled according to a control instruction from the control portion 90.

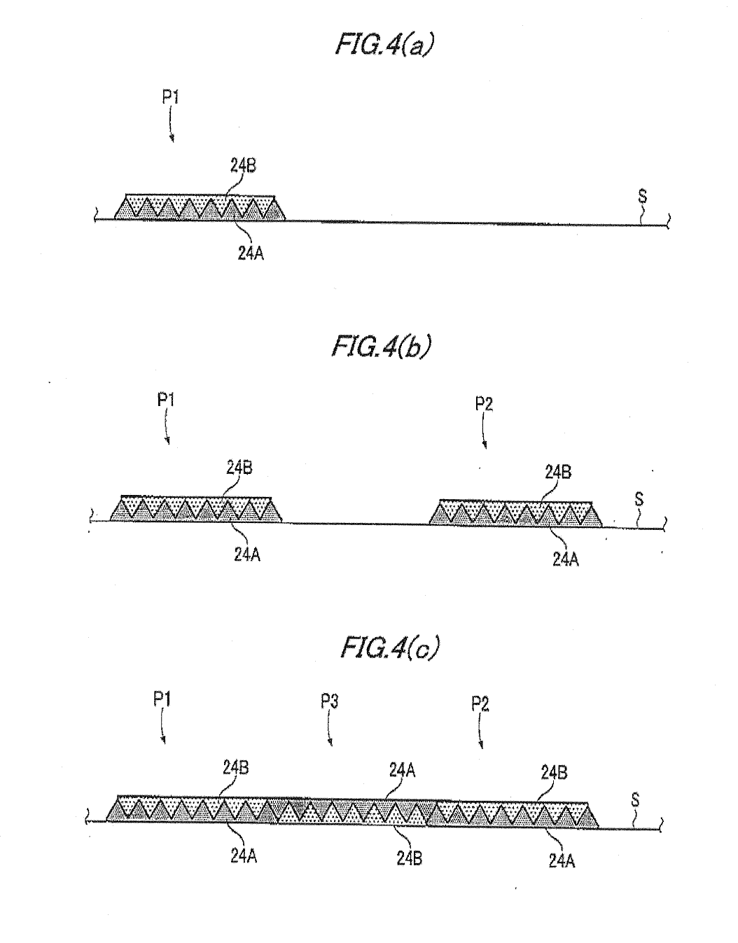

Firstly, while discharging the high-viscosity materials from the discharge portion 21 of the nozzle 20 by operating the pump 60, the robot 40 is operated to move the nozzle 20 linearly in the application direction, thereby executing a first application step. Consequently, as shown in FIG. 4 (a), the two high-viscosity material layers 24A and 24B are superimposed, whereby a first high-viscosity material layered body P1 (first high-viscosity material applied portion P1) having a substantially trapezoidal cross section shape is formed in a belt-like shape.

Next, by operating the robot 40, the nozzle 20 is moved from the application start position of the first application step to a position spaced by a previously set distance in a direction perpendicular to the application direction. After then, while discharging the high-viscosity materials from the discharge portion 21 of the nozzle 20 by operating the pump 60, the robot 40 is operated to move the nozzle 20 linearly in the same application direction as the first application step, thereby executing a second application step. Consequently, as shown in FIG. 4 (b), the two high-viscosity material layers 24A and 24B are superimposed, whereby a second high-viscosity material layered body P2 (second high-viscosity material applied, portion P2) having a substantially trapezoidal cross section shape is formed in a belt-like shape while it is spaced from the first high-viscosity material layered body P1.

Next, by operating the robot 40, the nozzle 20 is moved to a position existing between the application end positions of the first and second application steps. After then, while discharging the high-viscosity materials from the discharge portion 21 of the nozzle 20 by operating the pump 60, the robot 40 is operated to move the nozzle 20 linearly in the opposite direction to the application direction of the first and second application steps, thereby executing a third application step. Consequently, as shown in FIG. 4(c), the two high-viscosity material layers 24A and 24B are superimposed, whereby a third high-viscosity material layered body P3 (third high-viscosity material applied portion P3) having a substantially trapezoidal cross section shape is formed in a belt-like shape while its end portions are contacted with the end portions of the first and second high-viscosity material layered bodies P1 and P2. The three belt-shaped high-viscosity material layered bodies P1 to P3 are arranged side by side while their respective end portions are superimposed, on top of each other.

The third high-viscosity material layered body P3, differently from the first and second high-viscosity material layered bodies P1 and P2, has a cross section the shape of which is a substantially trapezoidal shape with its relatively minor side constituting its bottom side. The reason for this is that, since the application direction in the third application step is opposite to the application direction in the first and second application steps, the high-viscosity material layer 24A formed of the high-viscosity materials discharged from the opening 21A is put on the high-viscosity material layer 24B formed of the high-viscosity materials discharged from the opening 21B.

The two end portions of the third high-viscosity material layered body P3, most preferably, may respectively he fitted with and superimposed on the end portions of the first and second third high-viscosity material layered bodies P1 and P2. In this case, the first to third high-viscosity material layered bodies P1 to P3, as a whole, have a substantially trapezoidal cross section shape and have a uniform thickness in the wide areas thereof except for their two end portions occupying the small areas thereof.

Also, in some cases, the two end portions third high-viscosity material layered body P3 may not be fitted with the end portions of the first and second high-viscosity material layered bodies P1 and P2 due to an error. However, even in this case, since the end portions of the respective high-viscosity material layered bodies P1, P1 and P3 are inclined, even when they are superimposed, they cannot rise so much. This can prevent the superimposed end portions from interfering with peripheral part such as a floor mat placed ma high-viscosity material coating (that is, the soundproof/vibration-proof sheet Provided on the coating surface) which is a high-viscosity material applied member constituted of the three parallel arranged high-viscosity material layered bodies P1, P1 and P3, thereby having no ill influence on their assembling performance.

Here, in the third application step, the nozzle 20 may also be re-assembled in such a manner that the direction of the discharge port 21 is switched, whereby the materials may be applied in the same direction as the application direction of the first and second application steps. However, this is not preferred when the time and labor to re-assemble the nozzle 20 are taken into consideration.

Also, when only the two high-viscosity material layered bodies are formed on the coating surface S, in the second application step, the high-viscosity materials may be applied in the opposite direction to the application direction of the first application step to thereby superimpose the end portion of the second high-viscosity material layered body on the end portion of the first high-viscosity material layered body.

Even when the coating surface S has an uneven shape in order to facilitate the teaching of the applicator gun 10, in some cases, while moving the nozzle 20 horizontally, the materials are applied. In such cases, especially, the distance between the nozzle 20 and coating surface S can be increased, Therefore, in the case that the individual triangular shapes of the opening 21A and 21B are separated from each other, there is a fear that the high-viscosity material layers 24A and 24B cannot be continuous with each ether. Thus, in order to positively form continuous belt-shaped high-viscosity material layers 24A and 24B, the bottom portions of the triangular shapes are connected together.

When the clearance between the openings 21A and 21B is excessively narrow, there is a fear that, before the high-viscosity material layer 24A is hardened sufficiently, the high-viscosity material layer 24B can be put on the layer 24A to thereby deform the shape of the layer 24A, especially the shape of the end portion thereof. Also, when the openings 21A and 21B are formed integrally, there is formed a thick high-viscosity material layer. In this case, the thickness cannot be made uniform.

Now, description will be given below of a high-viscosity material application device according to a second embodiment.

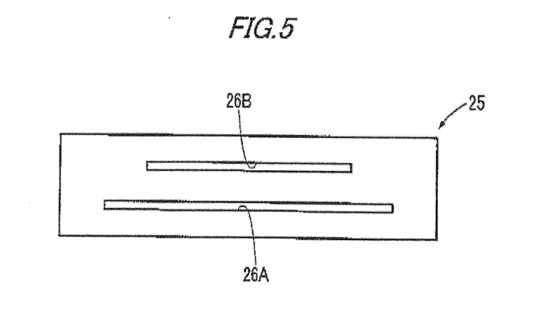

This application device, as shown in FIG. 5, is different from the above application device 100 only in the discharge portion 25 which is formed in the lower surface of a nozzle 25.

Two openings 26A and 26B constituting the discharge portion 26 respectively have a rectangular shape the longitudinal direction of which is a direction (in the drawing, in the right and left direction) perpendicular to the application direction, and they are arranged parallel to each other. The longitudinal direction two end portions of the opening 26A are respectively longer by a given amount than those of the opening 26B. Thus, a shape obtained when the shapes of the openings 26A and 26B are put on each other provides a rectangular shape including step portions in its two end portions, while the shape is asymmetric in the application direction and symmetric in a direction perpendicular to the application direction.

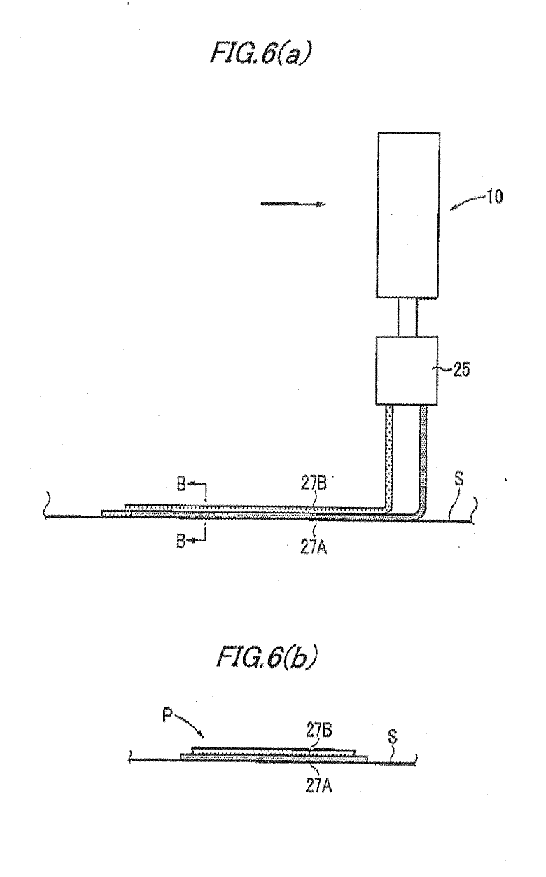

Since the openings 26A and 26B are spaced in the application direction, as shown in FIG. 6(a), high-viscosity materials respectively discharged simultaneously from the openings 26A and 26B are allowed to flow down while they are spaced in the application direction, and are then applied onto the coating surface S.

When the opening 26A is situated on the front side in the application direction with the opening 26B on the rear side in the application direction, a high-viscosity material layer 27B formed of high-viscosity materials discharged from the opening 26B is put on a high-viscosity material layer 27A formed, of high-viscosity materials discharged from the opening 26A. In the case of a high-viscosity material layered body P which is formed when the two high-viscosity material layers 27A and 27B are put on each other, as shown in FIG. 6 (b), its cross section provides a rectangular shape including steps in its two end portions similarly to the shape obtained when the shapes of the openings 26A and 26B are superimposed in the application direction, while this shape is asymmetric in the application direction and symmetric in a direction perpendicular to the application direction.

Here, the space between the openings 26A and 26B, the temperature and shear rate of the high-viscosity materials when they are discharged from the nozzle 25, the moving speed of the nozzle 25 and the like can be determined properly in consideration, of the distance from the nozzle 25 to the coating surface S, the outside air temperature, the operation efficiency and the like in order that, when the two high-viscosity material layers 27A and 27B are put on each other, the shape of the end portion of the lower high-viscosity material layer 27A can be prevented against deformation.

For example, the length of the short side of the rectangular shape of the openings 26A and 26B may be about 0.3 mm to several mm or less, the space between the openings 26A and 26B may be about several mm, the temperature of the high-viscosity material when it is discharged from the nozzle 25 may be 28° to 30°, the shear rate of the high-viscosity material when it is discharged from the nozzle 25 may be 10000/sec to 20000/sec, and the moving speed of the nozzle 25 may be 200 mm/min to 1500 mm/min.

The above-structured application device, while moving relatively to the coating surface S, discharges the heated high-viscosity materials from the discharge portion 26. The discharged high-viscosity materials are allowed to flow down and reach the coating surface S, where they are cooled and hardened, thereby forming a belt-shaped high-viscosity material layered body P.

Now, description will be given below of a high-viscosity material application method using this application device. Since this application method is similar to the high-viscosity material application method of the first embodiment, the description thereof is simplified.

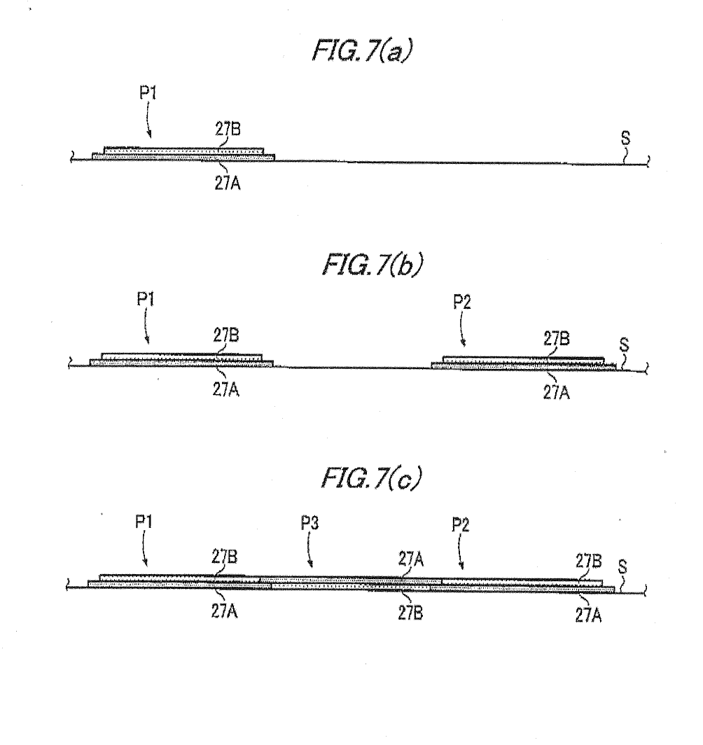

Firstly, there is executed a first application step. As shown in FIG. 7 (a), the two high-viscosity material layers 27A and 27B are superimposed on each other to thereby form a first belt-shaped high-viscosity material layered body P1 having a rectangular shape the cross section of which has a shape including step portions in its two end portions.

Next, there is executed a second application step. As shown in FIG. 7 (b), the two high-viscosity material layers 27A and 27B are superimposed to thereby form a second belt-shaped high-viscosity material layered body P2 having a rectangular shape the cross section of which has a shape including step portions in its two end portions, while the second layered body P2 is spaced from the first layered body P1.

Next, there is executed a third application step. As shown in FIG. 7(c), the two high-viscosity material layers 27A and 27B are superimposed to thereby form a third belt-shaped high-viscosity material layered body P3 having a rectangular shape the cross section of which has a shape including step portions in its two end portions, while the end portions of the third layered body P3 are contacted with the end portions of the first and second layered bodies P1 and P2. The three belt-shaped high-viscosity material layered bodies P1 to P3 are arranged side by side with their end portions superimposed on each other.

The third high-viscosity material layered body P3, differently from the first and second high-viscosity material layered bodies P1 and P2, has a cross section of a rectangular shape including cut-out step portions in the lower end portions of its two ends. The reason for this is that, since the application direction in the third application step is opposite to the application direction in the first and second application steps, the high-viscosity material layer 27A formed of the high-viscosity materials discharged from the opening 26A is put on the high-viscosity material layer 27B formed of the high-viscosity materials discharged from the opening 26B.

The two end portions of the third high-viscosity material layered body P3, most preferably, may respectively be fitted with and superimposed on the end portions of the first and second third high-viscosity material layered bodies P1 and P2. In this case, the first to third high-viscosity material layered bodies P1 to P3, as a whole, have a substantially trapezoidal cross section shape and have a uniform thickness in their wide areas except or their two end portions occupying their small areas.

Also, in some cases, the two end portions of the third high-viscosity material layered body P3 may not be fitted with the end portions of the first and second high-viscosity material layered bodies P1 and P2 due to an error. However, even in this case, since the end portions of the respective high-viscosity material layered bodies P1, P1 and P3 include the step portions, even when the end portions are superimposed on each other, they cannot be raised so much. This can prevent the end portions from interfering with a peripheral part such as a floor mat to be placed on the three parallel arranged high-viscosity material layered bodies P1, P1 and P3 (that is, a floor mat placed on the soundproof/vibration-proof sheet on the coating surface), thereby having no ill influence on their assembling performance.

Here, in the third application step, the nozzle 25 may also be re-assembled in such a manner that the direction of the discharge portion 26 is switched over to the same direction as the application direction in the first and second application steps, However, this is not preferred when the time and labor to re-assemble the nozzle 25 are taken into consideration.

Also, when only the two high-viscosity material layered bodies are formed on the coating surface S, in the second application step, the high-viscosity materials may be applied in the opposite direction to the application direction in the first application step to thereby superimpose the end portion of the second high-viscosity material layered body on the end portion of the first high-viscosity material layered body.

Now, description will be given below of a high-viscosity material application device according to a third embodiment.

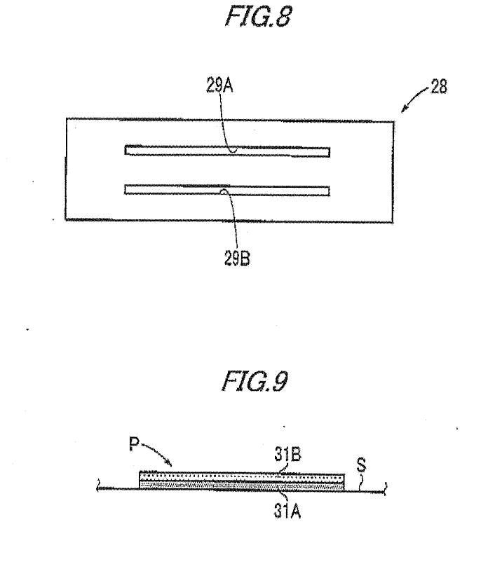

This application device, as shown in FIG. 8, is different from the above application device 100 only in the discharge portion 29 formed in the lower surface of a nozzle 28.

Opening 29A and 29B constituting a discharge portion 29 respectively have a rectangular shape the longitudinal direction of which is a direction (in the drawing, the right and left direction) perpendicular to the application direction, while they are arranged parallel to each other. The opening 29A and 29B have the same length in their longitudinal directions. Thus, when the shapes of the opening 29A and 29B are superimposed on each other in the application direction, there is provided a rectangular shape which is symmetric in the application direction and in a direction perpendicular to the application direction.

Since the opening 29A and 29B are spaced in the application direction, as shown in FIG. 9, high-viscosity materials discharged simultaneously from the opening 29A and 29B are spaced in the application direction and are allowed to flow down onto the coating surface S.

In the case that the materials are applied in a state where the opening 29A is situated on the front side in the application direction with the opening 29B on the rear side, a high-viscosity material layer 31B formed of materials discharged from the opening 29B is put on a high-viscosity material layer 31A formed of materials discharged from the opening 29A. When these two high-viscosity material layers 31A and 31B are put on each other, there is provided a high-viscosity material layered body P. The cross section of the layered body P has a rectangular shape similar to the shape obtained when the shapes of the openings 29A and 29B are superimposed in the application direction, while this shape is symmetric in the application direction and in a direction perpendicular to the application direction.

Here, the space between the openings 29A and 29B, the temperature and, shear rate of the high-viscosity materials when they are discharged from the nozzle 28, the moving speed of the nozzle 28 and the like can be determined properly in consideration of the distance from the nozzle 25 to the coating surface S, the outside air temperature, the operation efficiency and the like in order that, when the two high-viscosity material layers 29A and 29B are put on each other, the shape of the end portion of the lower high-viscosity material layer 29A can be prevented against deformation.

For example, the length of the short side of the rectangular shape of the openings 29A and 29B may be about 0.3 mm to several mm or less, the space between the openings 29A and 29B may be about several mm, the temperature of the high-viscosity materials when they are discharged from the nozzle 28 may be 28° to 30°, the shear rate of the high-viscosity materials when they are discharged from the nozzle 28 may be 10000/sec to 20000/sec, and the moving speed of the nozzle 28 may be 200 mm/min to 1500 mm/min.

The above-structured, application device, while moving relatively to the coating surface S, discharges the heated high-viscosity materials from the discharge portion 28. The discharged high-viscosity materials are allowed to flow down and reach the coating surface S, where they are cooled and hardened, thereby forming a belt-shaped, high-viscosity material layered body P.

Now, description will be given below of a method for applying high-viscosity materials using this application device. This method is not suitable for a case where a plurality of belt-shaped high-viscosity material layered bodies P are arranged side by side, but is suitable for a case where only one belt-shaped high-viscosity material layered body P is formed, or a case where one of mutually adjoining belt-shaped high-viscosity material layered P is formed while it is separated from the other.

While discharging the high-viscosity materials from the discharge portion 29 of the nozzle 28 by operating the pump 60, the robot 40 is operated to move the nozzle 28 linearly in the application direction, thereby executing a first application step. Consequently, as shown in FIG. 9, the two high-viscosity material layers 31A and 31B are put on each other to thereby form a belt-shaped high-viscosity material layered body P the cross section shape of which has a rectangular shape.

Here, there may also be used a nozzle including a discharge portion constituted of only one opening. In this case, after the lower high-viscosity material layers are all formed, the higher high-viscosity material layer is formed on the lower layers. However, since the time necessary for forming such layers is long, this structure is not preferred.

Although description has been given heretofore of the embodiments of the invention, the invention is not limited to them. For example, the discharge portion is not limited to two openings but it may also be constituted of three or more openings. In this case, a high-viscosity material layered body is constituted of three or more high-viscosity material layers put on top of each other.

Also, especially when the high-viscosity material layered body does not need so much large thickness, the high-viscosity material layer maybe formed of a single high-viscosity material layer. In this case, the shape of the end portions of high-viscosity material single layers to be superimposed has point symmetry. For example, there may be formed only one opening constituting a discharge portion, the shape of this opening may be a substantially trapezoidal shape or a rectangular shape including step portions in its two end portions, and the shape of the cross section of the high-viscosity material layer may be a substantially trapezoidal shape or a rectangular shape including step portions in its two end portions.

Also, in the first and second embodiments, description has been given of a case where there are formed two-row or three-row high-viscosity material layered bodies P side by side. However, this is not limitative but a one-row high-viscosity material layered body P or four or more rows of high-viscosity material layered bodies P may also be formed.

When the plurality of rows of high-viscosity material layered bodies P are formed adjacently, description has been given of the case where the discharge portions 21 and 26 include the openings 21A, 21B and 26A, 26B. However, this is not limitative but the openings of the discharge portion may be structured such that the shape obtained when their shapes are put on each other in the application direction is asymmetric in the application direction and symmetric in a direction perpendicular to the application direction. For example, the shape of the opening may be a wavy shape.

Also, when a single-row high-viscosity material layered body P is formed, description has been given of the case where the discharge portion 29 includes the openings 29A and 29B. However, this is not limitative but the shape obtained when the shapes of the openings are put on each other in the application direction may be a rectangular shape, or the discharge portion 29 may also be constituted of a plurality of openings respectively having different shapes.

According to the above-mentioned embodiments, in a high-viscosity application device which, while moving relatively to the coating surface, discharges high-viscosity materials from the discharge portion to apply them onto the coating surface, the discharge portion may have a plurality of successive openings spaced from each other in the application direction.

In this case, the high-viscosity materials discharged from the plurality of successive openings spaced in the application direction are applied onto the coating surface, thereby forming the high-viscosity material layer. In the case of the high-viscosity material layer, when its thickness exceeds a certain level, it is difficult for the high-viscosity material layer to have a uniform thickness through application of the high-viscosity material layer. Thus, when a high-viscosity material layer having a uniform thickness is necessary, a high-viscosity material layer having such thickness is as allows the high-viscosity material application to form a uniform thickness may be formed of high-viscosity materials discharged from the opening situated on the front side in the application direction and, after then, on this layer, there may be put a high-viscosity material layer formed of the high-viscosity materials discharged from the opening situated on the rear side in the application direction, thereby being able to form a high-viscosity material layered body having a uniform thickness as a whole. Thus, the thickness of this layered body can be made thick and uniform.

Further, when there is used a device including a discharge portion constituted of only one opening, to put a plurality of high-viscosity material layers on each other, there are necessary such number of application steps as equal to the number of layers. When compared with this, in the case of a device the discharge portion of which is constituted of a plurality of successive openings spaced in the application direction, using a single application step, there can be formed the same number of high-viscosity material layers as the number of the openings. This can shorten the time necessary to execute whole steps.

In the above structure, the shape obtained when the shapes of the plurality of openings are put on each other in the application direction may be asymmetric in the application direction and symmetric in a direction perpendicular to the application direction.

In this case, the shapes of the end portions of the high-viscosity material layers put on the coating surface in one application step are asymmetric in the vertical direction (in the thickness direction) and symmetric in the horizontal direction. Therefore, even when the end portions of the high-viscosity material layers put on each other, they hardly rise. This prevents such end portions from interfering with a peripheral part, thereby reducing ill influences on their assembling performance.

The shape of the respective openings may also be a shape obtained by connecting together the bottom portions of the triangular shapes in a direction perpendicular to the application direction.

Also, the shape of the respective openings may so be a rectangular shape.

Further, a shape obtained when the shapes of the plurality of openings are put on each other in the application direction may be a rectangular shape.

Also, according to the above embodiments, an application method for applying high-viscosity materials onto a coating surface may include a step of applying high-viscosity materials onto a coating surface to form a first high-viscosity material layer, and a step of applying high-viscosity materials onto the first high-viscosity material layer to form a second high-viscosity material layer, thereby forming a high-viscosity material layered body where the second high-viscosity material layer is put on the first high-viscosity material layer.

In this method, since the high-viscosity material layered body is formed of the two high-viscosity material layers, its thickness can be made thick and uniform. In the case that the thickness of the high-viscosity material layer exceeds a certain thickness, the thickness is difficult to be uniform through the application. Thus, when there is necessary a high-viscosity material layer having a uniform thickness, there may be formed a first high-viscosity material layer having such thickness as can be set uniform through the application and after then, on the first layer, there may be formed a second high-viscosity material layer, thereby being able to form a high-viscosity material layered body having a uniform thickness as a whole.

The first high-viscosity material layer forming step and the second high-viscosity material layer forming step may also be overlapped in terms of time.

In this case, when compared with a case where, after the first high-viscosity material layer is formed completely, the high-viscosity material layer is formed, the time of the whole steps can be shortened.

Also, after a first high-viscosity material layered body is formed, a second high-viscosity material layered body may be formed with its end portion superimposed, on the end portion of the first layered body and the shape of the superimposed end portions may have point symmetry.

In this case, since the shape of the superimposed end portions of the high-viscosity material layered bodies has point symmetry, the superimposed end portions will not rise. This prevents the end portions from interfering with a peripheral part and does not have ill influence on their assembling performance.

Further, after a first high-viscosity material layered body is formed, a second high-viscosity material layered body may be formed while it is spaced from the first piled layer, and a third a high-viscosity material layered body may be further formed with its end portions superimposed on the mutually facing end portions of the first and second high-viscosity material layered bodies.

The application directions when forming the two high-viscosity material layered bodies having the superimposed end portions may be opposite to each other.

In this case, since the application device need not be moved in the application direction from the position of the end of formation of a first high-viscosity material layered body to the position of the start of formation of a second high-viscosity material layered body, the layered body forming time can be shortened.

Also, according to the above embodiments, in a high-viscosity material coating produced by applying the high-viscosity materials onto the coating surface, the end portions of two high-viscosity material applied portions may be superimposed on each other and the thus superimposed end portions may have point symmetry.

In this structure, since the shape of the superimposed end portions of the high-viscosity material applied portions has point symmetry, the end portions do not rise. This prevents the end portions from interfering with a peripheral part, thereby avoiding ill influence on their assembling performance.

The high-viscosity material applied portion may be a high-viscosity material layered body which is formed by putting layers respectively formed of high-viscosity materials on each other.

In the case of the layer formed of the high-viscosity materials, when its thickness exceeds a certain level, the thickness is hard to be made uniform through the material application. Thus, when there is necessary a high-viscosity material layer having a uniform thickness, by putting high-viscosity material layers on each other, there can be provided a high-viscosity material layer having a uniform thickness as a whole.

### Description of Reference Numerals and Signs

10: Welding gun
20, 25, 28: Nozzle
21, 26, 29: Discharge portion
21A, 21B, 26A, 26B, 29A, 29B: Opening
24A, 24B, 27A, 27B, 31A, 31B: High-viscosity material layer
P, P1, P2, P3: High-viscosity material layered body
30: Hose
40: Robot
100: Application device

What is claimed is:

1. A high-viscosity material application device in which a high-viscosity material is discharged from a discharge portion while relatively moving with respect to a coating surface and the high-viscosity materials is applied onto the coating surface,
wherein the discharge portion includes a plurality of successive openings spaced from each other in an application direction.

2. The high-viscosity material application device according to claim 1, wherein a shape constituted by superimposing shapes of the plurality of openings in the application direction is asymmetric in the application direction and is symmetric in a direction perpendicular to the application direction.

3. The high-viscosity material application device according to claim 2, wherein each of the openings has a shape in which bottom portions of a plurality of triangular shapes are aligned and connected together in the direction perpendicular to the application direction.

4. The high-viscosity material application device according to claim 2, wherein each of the openings has a rectangular shape.

5. The high-viscosity material application device according to claim 1, wherein a shape constituted by superimposing shapes of the plurality of openings in the application direction is a rectangular shape.

6. A high-viscosity material application method in which a high-viscosity material is applied onto a coating surface, the method comprising:
forming a first high-viscosity material layer by applying the high-viscosity material onto the coating surface; and
forming a second high-viscosity material layer by applying the high-viscosity material onto the first high-viscosity material layer, and forming a high-viscosity material layered body in which the second high-viscosity material layer is laid on the first high-viscosity material layer.

7. The high-viscosity material application method according to claim 6, wherein the step of forming the first high-viscosity material layer and the step of forming the second high-viscosity material layer are overlapped in terms of time.

8. The high-viscosity material application method according to claim 6, wherein said high-viscosity material layered body is a first high-viscosity material layered body, the method further comprising:
forming a second high-viscosity material layered body, in such a manner that an end portion of the second high-viscosity material layered body is superimposed on an end portion of the first high-viscosity material layered body and a shape of the superimposed end portions has point symmetry, after the first high-viscosity material layered body is formed.

9. The high-viscosity material application method according to claim 8, wherein an application direction of the first high-viscosity material layered body and an application direction of the second high-viscosity material layered body are opposite to each other.

10. The high-viscosity material application method according to claim 6, wherein said high-viscosity material layered body is a first high-viscosity material layered body, the method further comprising:
forming a second high-viscosity material layered body spaced from the first high-viscosity material layered body, after the first high-viscosity material layered body is formed; and
forming a third high-viscosity material layered body in such a manner that end portions of the third high-viscosity material layered body are respectively superimposed on an end portion of the first high-viscosity material layered body and an end portion of the second high-viscosity material layered body.

11. The high-viscosity material application method according to claim 10, an application direction of the third high-viscosity material layered body is opposite to an application direction of the first high-viscosity material layered body and the second high-viscosity material layered body.

12. A high-viscosity material coating in which a high-viscosity material is applied onto a coating surface, wherein end portions of two high-viscosity material applied portions are superimposed on each other and a shape of the superimposed end portions has point symmetry.

13. The high-viscosity material coating according to claim 12, wherein each of the high-viscosity material applied portions comprises a high-viscosity material layered body including superimposed high-viscosity material layers formed of the high-viscosity material.

14. A soundproof/vibration-proof sheet comprising the high-viscosity material coating according to claim 12.
